(19) United States
(12) Patent Application Publication
(10) Pub. No.: US 2022/0013958 A1
(43) Pub. Date: Jan. 13, 2022

(54) CONNECTOR

(71) Applicants: YAZAKI CORPORATION, Tokyo (JP); HONDA MOTOR CO., LTD., Tokyo (JP)

(72) Inventors: Kazuyuki Ochiai, Asaka-shi (JP); Daisuke Fujihira, Asaka-shi (JP); Shintaro Matsuda, Asaka-shi (JP); Tomoyuki Miyakawa, Utsunomiya-shi (JP); Kozo Oishi, Utsunomiya-shi (JP)

(21) Appl. No.: 17/483,808

(22) Filed: Sep. 24, 2021

Related U.S. Application Data
(63) Continuation of application No. PCT/JP2020/008191, filed on Feb. 27, 2020.

(30) Foreign Application Priority Data
Mar. 26, 2019 (JP) 2019-059303

(51) Int. Cl. H01R 13/631; H01R 13/648

(52) U.S. Cl. CPC H01R 13/631; H01R 2201/26; H01R 13/6485

(57) ABSTRACT

A connector includes a housing, a holder, and a short-circuiting terminal. The holder is non-movable to a formal locking position when terminals, which are short-circuiting targets, are not inserted into a terminal receiving chamber. The holder is movable to the formal locking position when the terminals, which are short-circuiting targets, are inserted into a sufficient insertion position of the terminal receiving chamber. A contact member of the short-circuiting terminal is in contact with the terminals, which are short-circuiting targets, and the terminals, which are short-circuiting targets, are short-circuited when the terminals, which are short-circuiting terminals, are inserted into the sufficient insertion position and the holder is moved to the formal locking position.

### CROSS-REFERENCE TO RELATED APPLICATIONS

This is a continuation of International Application No. PCT/JP2020/008191 filed on Feb. 27, 2020, and claims priority from Japanese Patent Application No. 2019-059303 filed on Mar. 26, 2019, the entire content of which is incorporated herein by reference.

### TECHNICAL FIELD

The present invention relates to a connector.

### BACKGROUND ART

From the related art, as a connector including a housing provided in a terminal receiving chamber that accommodates a terminal, a connector including a front holder for detecting an insufficiently inserted state of a terminal inserted into the terminal receiving chamber has been widely known.

The front holder is mounted on the housing to be movable in a fitting direction of the housing and a counterpart housing between a temporary locking position and a formal locking position. The front holder is configured to be movable from the temporary locking position to the formal locking position when the terminal is at a sufficient insertion position, and to be non-movable from the temporary locking position to the formal locking position when the terminal is at an insufficient insertion position. In this manner, when the terminal is at the insufficient insertion position, the front holder becomes non-movable from the temporary locking position to the formal locking position, and accordingly, the insufficiently inserted state of the terminal can be easily detected.

Furthermore, as a connector of this type, a connector including short-circuiting terminals that short-circuit a plurality of terminals received in a plurality of terminal receiving chambers is also widely known.

By providing the short-circuiting terminals on the connector in this manner, for example, in a case where the plurality of terminals, which are targets of short-circuiting by the short-circuiting terminal, are connected to a wiring harness that supplies control signals to an inflator of an in-vehicle airbag system, it is possible to reliably prevent the occurrence of malfunctions and misfires of the inflator due to static electricity.

As for details of the above resin structure, refer to JP-B-5933380 and JP-B-5599300.

In general, a connector in which a front holder is mounted on a housing is conveyed in a state where the front holder is held at the temporary locking position. However, during the conveyance, such as during shipping, there is a case where the front holder unintendedly moves from the temporary locking position to the formal locking position due to contact of the front holder with peripheral members. It is desired to suppress such unintended movement of the front holder to the formal locking position.

In order to address this request, a case of providing a new mechanism or member dedicated to suppressing the unintended movement of the front holder to the formal locking position, can be considered. However, in this case, the manufacturing cost will increase due to the increase in the number of components.

Therefore, it is desirable to suppress the unintended movement of the front holder to the formal locking position without providing a new dedicated mechanism or member.

### SUMMARY OF INVENTION

Aspect of non-limiting embodiments of the present disclosure relates to provide a connector that can suppress unintended movement of the holder from the temporary locking position to the formal locking position during the conveyance, such as during shipping.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a connector comprising:
a housing: having a terminal receiving chamber to hold a terminal; and a lance;
a holder mounted on the housing to be movable in a fitting direction of the housing and a counterpart housing between a temporary locking position and a formal locking position, the holder having a detection member, the holder being configured to be movable to the formal locking position by being allowed a movement of the detection member without an interference to the lance upon the terminal being at a sufficient insertion position, and the holder being configured to be non-movable to the formal locking position due to the interference of the detection member to the lance upon the terminal being at an insufficient insertion position; and
a short-circuiting terminal fixed to the housing and having an elastically deformable contact member, the contact member making a contact with a plurality of the terminals received in a plurality of the terminal receiving chambers to cause a short-circuit of the plurality of the terminals,
the holder and the short-circuiting terminal being configured not to allow a movement of the holder to the formal locking position under a first state where the holder is at the temporary locking position and at least one of the plurality of the terminals subjected to the short-circuit using the short-circuiting terminal is not inserted into the corresponding terminal receiving chamber,
the holder and the short-circuiting terminal being configured to avoid a contact of the contact member with the plurality of the terminals and to allow the movement of the holder to the formal locking position under a second state where the plurality of the terminals subjected to the short-circuit using the short-circuiting terminal are inserted into the sufficient insertion position of the plurality of the terminal receiving chambers, and
the holder and the short-circuiting terminal being configured to make the contact of the contact member with the plurality of the terminals to cause the short-circuit of the plurality of the terminals under a third state where the holder is moved to the formal locking position.

### BRIEF DESCRIPTION OF DRAWINGS

Exemplary embodiment(s) of the present invention will be described in detail based on the following figures, wherein:

FIG. 1 is a perspective view of a connector according to an embodiment of the present invention;

FIG. 2A is a perspective view of a housing illustrated in FIG. 1, and FIG. 2B is a perspective view of a cross-section cut along line A-A of FIG. 2A;

FIG. 3 is a sectional view cut along line B-B of FIG. 2A;

FIG. 4 is a perspective view of a short-circuiting terminal illustrated in FIG. 1;

FIG. 5A is a perspective view of a front holder illustrated in FIG. 1, FIG. 5B is a perspective view of a cross-section cut along line C-C of FIG. 5A, and FIG. 5C is a perspective view cut along line D-D of FIG. 5A;

FIG. 6A is a view corresponding to FIG. 3 in a state where a short-circuiting terminal is not mounted, a short-circuiting target terminal is not inserted, and the front holder is at a temporary locking position. FIG. 6B is a view corresponding to FIG. 3 in a state where no short-circuiting terminal is mounted, the short-circuiting target terminal is not inserted, and the front holder is at a formal locking position;

FIG. 7A is a view corresponding to FIG. 3 in a state where the short-circuiting terminal is mounted, the short-circuiting target terminal is not inserted, and the front holder is at the temporary locking position. FIG. 7B is an enlarged view around the detection member of FIG. 7A;

FIG. 8A is a view corresponding to FIG. 3 in a state where the short-circuiting terminal is mounted, the short-circuiting target terminal is inserted into a sufficient insertion position, and the front holder is at the temporary locking position. FIG. 8B is an enlarged view around the detection member of FIG. 8A; and

FIG. 9A is a view corresponding to FIG. 3 in a state where the short-circuiting terminal is mounted, the short-circuiting target terminal is inserted into the sufficient insertion position, and the front holder is at the formal locking position. FIG. 9B is an enlarged view around the detection member of FIG. 9A.

### DESCRIPTION OF EMBODIMENTS

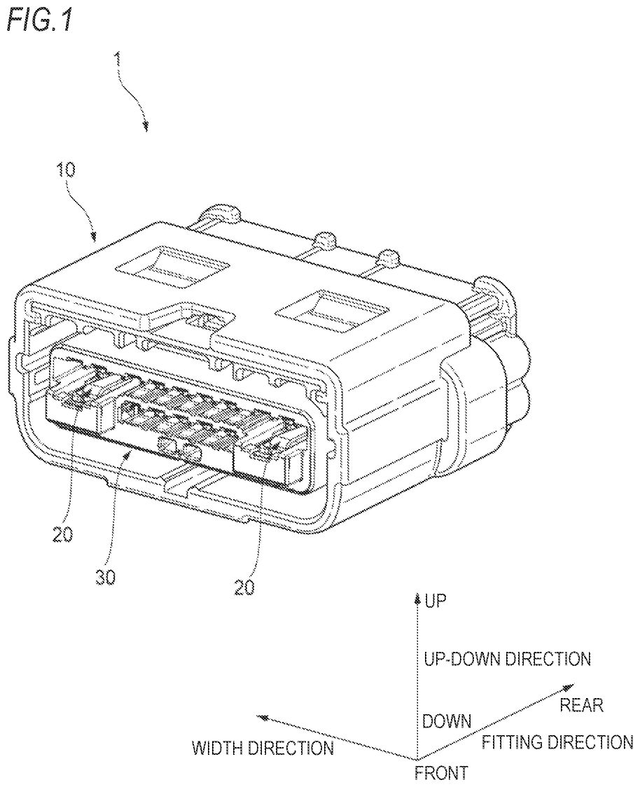

Hereinafter, a connector 1 according to an embodiment of the present invention will be described. For convenience of description, “fitting direction,” “width direction,” “up-down direction,” “front,” “rear,” “up,” and “down” are defined as illustrated in FIG. 1. The “fitting direction,” “width direction,” and “up-down direction” are orthogonal to each other. The fitting direction matches a fitting direction between the connector 1 and a counterpart connector (not illustrated), the front surface side (left side in FIG. 1) in the fitting direction in which the counterpart connector fits is a front side, and a rear surface side (right side in FIG. 1) in the opposite fitting direction is a rear side.

As illustrated in FIG. 1, the connector 1 is configured to include a housing 10, one pair of short-circuiting terminals 20 mounted on the housing 10, and a front holder 30 mounted on the housing 10. Hereinafter, each component of the connector 1 will be described in order.

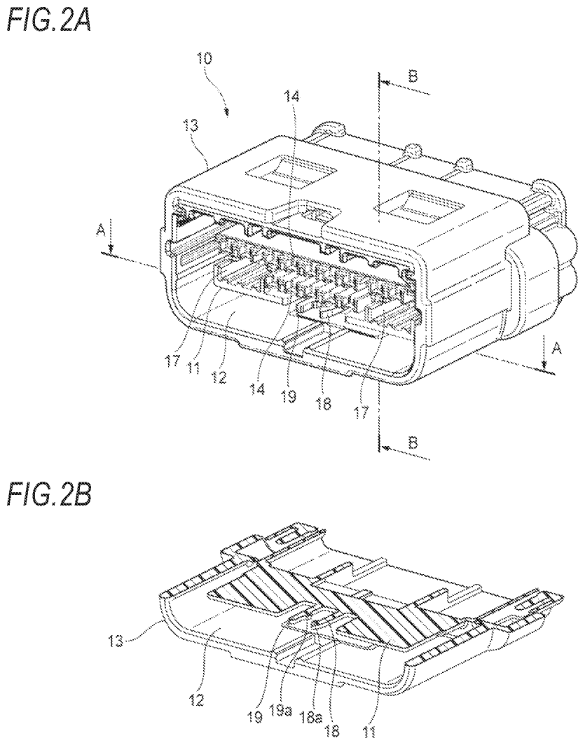

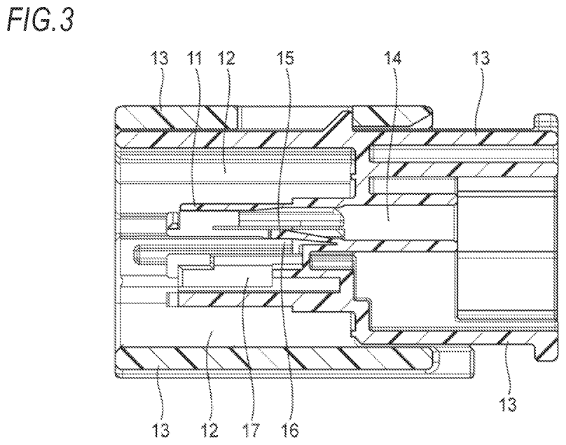

First, the housing 10 will be described. As illustrated in FIGS. 2A, 2B, and 3, the resin housing 10 integrally includes a substantially rectangular parallelepiped terminal accommodation unit 11 and a substantially square tube-shaped outer tube unit 13 that covers an outer periphery of the terminal accommodation unit 11 through an annular gap 12 that opens to the front side. The annular gap 12 functions as a space into which a frame body unit 31 of the front holder 30 is inserted when the front holder 30 is mounted. The frame body unit 31 will be described in detail later. In the present example, the outer tube unit 13 actually has a double structure including an outer side member and an inner side member, but since the double structure is well known, the detailed description thereof will be omitted here.

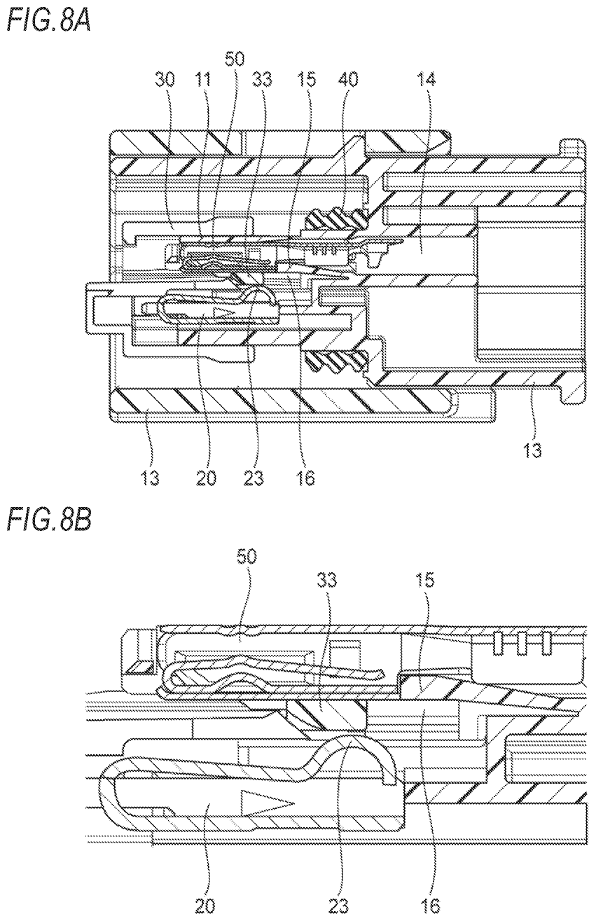

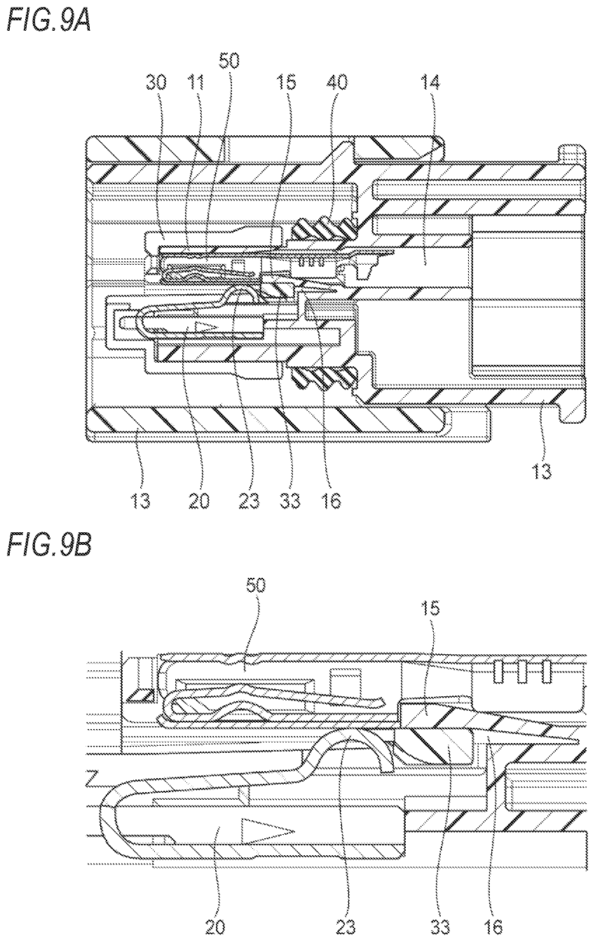

In the terminal accommodation unit 11, as illustrated in FIGS. 2A and 3, a terminal receiving chamber 14 for accommodating terminals 50 (refer to FIGS. 8A, 8B, 9A, and 9B) is formed to extend in the front-rear direction. In the present example, the plurality of terminal receiving chambers 14 are provided to be aligned in the width direction in two upper and lower stages. Specifically, in the lower stage, five terminal receiving chambers 14 are provided to be aligned in the width direction in the central region excluding both end parts of the terminal accommodation unit 11 in the width direction, and in the upper stage, nine terminal receiving chambers 14 are provided to be aligned in the width direction over substantially the entire region of the terminal accommodation unit 11 in the width direction.

As illustrated in FIG. 3, each terminal receiving chamber 14 includes a cantilevered lance 15 which is elastically deformable in the up-down direction to face the terminal receiving chamber 14 from below substantially at the center position in the fitting direction. In a state of not being elastically deformed (a state illustrated in FIG. 3), the lance 15 extends to be inclined forward and upward such that a tip end side slightly enters the terminal receiving chamber 14. By locking a predetermined corner portion of the terminal 50 inserted into the terminal receiving chamber 14 from the rear side, to the tip end of the lance 15, the lance 15 exhibits a function of retaining the terminal 50 to the rear side.

In the terminal receiving chamber 14, when the terminal 50 is at the sufficient insertion position (a state where the lance 15 exhibits a retaining function), the tip end of the lance 15 enters the corner portion of the terminal 50, and accordingly, the lance 15 is maintained in a state of not being elastically deformed (a posture illustrated in FIG. 3, hereinafter, referred to as “original position”). In a case where the lance 15 is at the original position, the detection member 33 of the front holder 30 can be inserted into a space 16 that faces the lower side surface (the side surface opposite to the terminal receiving chamber 14) of the lance 15. The detection member 33 will be described in detail later.

Meanwhile, when the terminal 50 is at the insufficient insertion position (in a state where the function of retaining the lance 15 is not exhibited), due to the fact that the tip end of the lance 15 cannot enter the corner portion of the terminal 50, the lance 15 is maintained in a posture which is elastically deformed downward (in the direction of going far away from the terminal receiving chamber 14). In this case, as the detection member 33 of the front holder 30 interferes with the tip end of the lance 15, which is elastically deformed downward, it becomes impossible for the detection member 33 of the front holder 30 to enter the space 16.

As illustrated in FIG. 2A, at both outer parts of five terminal receiving chambers 14 in the width direction in the lower stage among two upper and lower stages, one pair of short-circuiting terminal mounting spaces 17 for mounting one pair of short-circuiting terminals 20 is formed. As illustrated in FIG. 3, each short-circuiting terminal mounting space 17 is communicated in the up-down direction to the front region of the lance 15 in the pair of terminal receiving chambers 14 disposed adjacent to the corresponding end portion in the width direction among the nine terminal receiving chambers 14 in the upper stage.

Hereinafter, for convenience of description, there is also a case where each of the pair of terminal receiving chambers 14 communicated to each short-circuiting terminal mounting space 17 in the up-down direction is particularly called “short-circuiting target terminal receiving chamber 14”, and the terminal 50 inserted into the short-circuiting target terminal receiving chamber 14 is called “short-circuiting target terminal 50”. There is also a case where the terminal receiving chamber 14, which is not the short-circuiting target terminal receiving chamber 14, is called “general terminal receiving chamber 14,” and the terminal 50, which is not the short-circuiting target terminal 50, is called “general terminal 50”.

As illustrated in FIGS. 2A and 2B, one pair of cantilevered elastic pieces 18 and 19, which are elastically deformable in the width direction, are provided at the center portion of the lower portion of the terminal accommodation unit 11 in the width direction, to be aligned in the width direction and extend forward. The pair of elastic pieces 18 and 19 respectively has projections 18a and 19a that protrude inward in the width direction. The projections 18a and 19a have a function of locking the front holder 30 to the temporary locking position and the formal locking position. This function will be described in detail later.

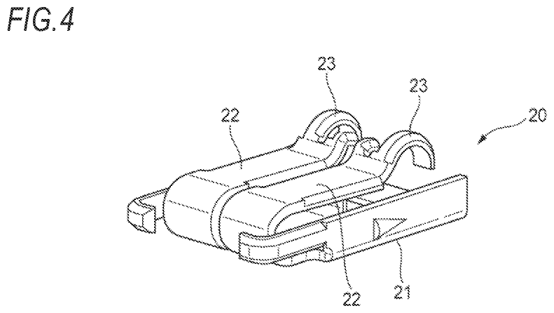

Next, the short-circuiting terminal 20 will be described. As illustrated in FIG. 4, the metal short-circuiting terminal 20 integrally includes a flat plate-shaped pedestal unit 21 and one pair of elastically deformable contact pieces 22 that bend upward from the front end portion of the pedestal unit 21 and extend rearward. The pair of contact pieces 22 are provided to be aligned in the width direction, and upwardly curved contact members 23 are formed respectively at the tip end portions (that is, rear end portions) of each contact piece 22.

The short-circuiting terminals 20 are mounted by being inserted respectively from the front into the pair of short-circuiting terminal mounting spaces 17 of the housing 10. In a state where the short-circuiting terminal 20 is mounted on the short-circuiting terminal mounting space 17, the pair of contact members 23 comes into contact with the pair of short-circuiting target terminals 50 inserted into the pair of short-circuiting target terminal receiving chambers 14 positioned above the pair of contact members 23 to short-circuit the pair of short-circuiting target terminals 50 to each other.

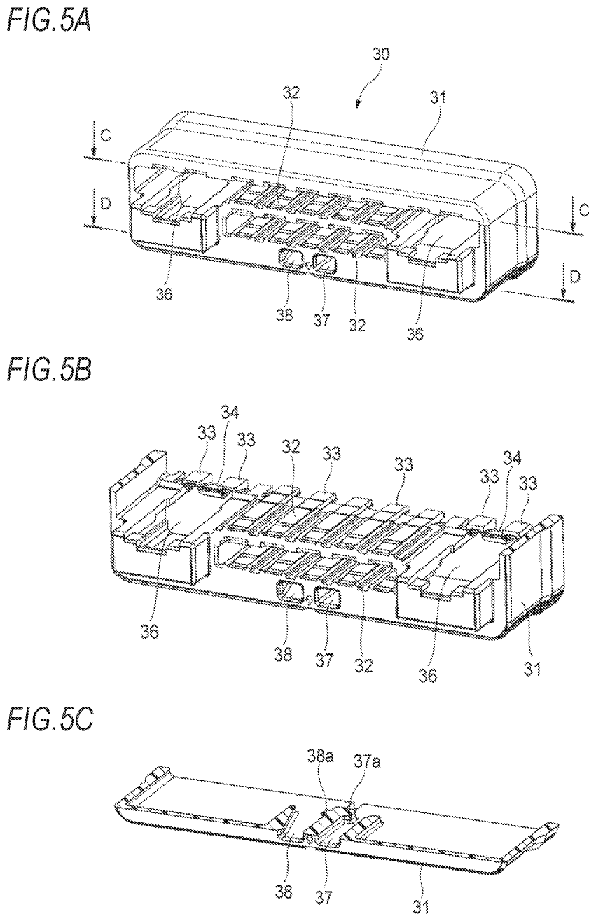

Next, the front holder 30 will be described. As illustrated in FIGS. 5A to 5C, the resin front holder 30 includes a square tube-shaped frame body unit 31. Inside the frame body unit 31, corresponding to the five general terminal receiving chambers 14 in two upper and lower stages, flat plate-shaped detection plates 32 are provided integrally with the frame body unit 31 to extend rearward in two upper and lower stages. At the rear end portions of the detection plates 32 in the two upper and lower stages, the detection members 33 (10 in total) corresponding to each of the five general terminal receiving chambers 14 in the two upper and lower stages are provided.

On the detection plate 32 in the upper stage, one pair of bridge units 34, which extends outward in the width direction from the rear end portions of both end portions in the width direction and is connected to the frame body unit 31, is provided. In each bridge unit 34, one pair of detection members 33 (four in total) corresponding to the corresponding pair of short-circuiting target terminal receiving chambers 14 is provided. Hereinafter, for convenience of description, there is also a case where the detection member 33 corresponding to the short-circuiting target terminal receiving chamber 14 is particularly called “short-circuiting target detection member 33”.

On the outer side in the width direction of both end portions in the width direction of the detection plate 32 in the upper stage, one pair of openings 36, which are upwardly open, is provided. Each opening 36 is provided so as not to interfere with the communication in the up-down direction between the short-circuiting terminal mounting space 17 of the housing 10 and the pair of short-circuiting target terminal receiving chambers 14 positioned above the short-circuiting terminal mounting space 17 in a state where the front holder 30 is mounted on the housing 10.

At the center portion in the width direction of the lower portion of the front holder 30, as particularly illustrated in FIG. 5C, one pair of insertion holes 37 and 38 penetrating in the fitting direction are provided to be aligned in the width direction. In the pair of insertion holes 37 and 38, projections 37a and 38a that protrude outward in the width direction are respectively formed. The projections 37a and 38a have a function of locking the front holder 30 to the temporary locking position and the formal locking position. This function will be described in detail later. Above, each component of the connector 1 is described.

Next, the operation when mounting the front holder 30 on the housing 10 will be described. Hereinafter, first, for convenience of description, a case where the short-circuiting terminal 20 is not mounted on the short-circuiting terminal mounting space 17 of the housing 10 will be described.

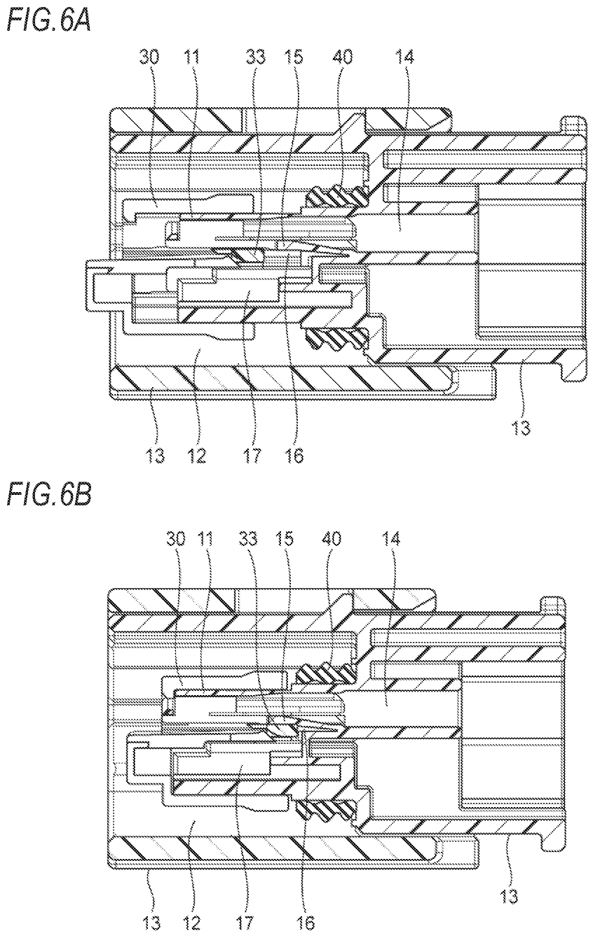

First, as illustrated in FIGS. 6A and 6B, a square tube-shaped rubber packing 40 is inserted into the annular gap 12 of the housing 10 from the front side, and is fixed to a predetermined position at the outer periphery of the terminal accommodation unit 11. A plurality of (in the present example, three) annular lip units are formed on the outer circumferential surface of the packing 40. The annular lip unit functions to watertightly seal the counterpart housing and the housing 10 when the counterpart housing is fitted into the housing 10.

Next, as illustrated in FIG. 6A, the front holder 30 is inserted into the annular gap 12 from the front side. At this time, the pair of elastic pieces 18 and 19 of the housing 10 is inserted into the insertion holes 37 and 38 of the front holder 30, respectively. As the insertion of the front holder 30 progresses, first, the projection 18a of the elastic piece 18 comes into contact with the projection 37a of the insertion hole 37.

After the projection 18a comes into contact with the projection 37a, the elastic piece 18 deforms elastically outward in the width direction as the insertion progresses, and accordingly, the projection 18a rides up on the projection 37a. After this, as the insertion progresses, the projection 18a overcomes the projection 37a, and accordingly, the elastic piece 18 elastically returns. Accordingly, in a state where the projection 18a is positioned in front of the projection 37a and the projection 19a is positioned behind the projection 38a, as the projection 19a and the projection 38a are respectively engaged together with the projection 18a and the projection 37a, as illustrated in FIG. 6A, the front holder 30 is held at the temporary locking position.

In this state, when the terminal 50 is inserted into the terminal receiving chamber 14 to the sufficient insertion position, as described above, the lance 15 is maintained at the original position (a posture illustrated in FIG. 6A). Therefore, a state where the detection member 33 (refer to FIG. 5B) of the front holder 30 can enter the space 16 is achieved. Therefore, in a state where the terminal 50 is at the sufficient insertion position, when the front holder 30 which is at the temporary locking position is pushed rearward, as illustrated in FIG. 6B, the detection member 33 enters the space 16, and accordingly, the front holder 30 moves to the formal locking position. At this time, in a state where the projection 19a of the elastic piece 19 overcomes the projection 38a of the insertion hole 38, and the projection 19a is positioned in front of the projection 38a, as the projection 19a and the projection 38a are engaged with each other, the front holder 30 is held at the formal locking position.

Meanwhile, in a state where the terminal 50 is al the insufficient insertion position, as described above, the lance 15 is maintained in a posture which is elastically deformed downward (that is, in the direction of separating from the terminal receiving chamber 14). Therefore, due to the interference between the tip end of the lance 15 and the detection member 33, it becomes impossible for the detection member 33 to enter the space 16. As a result, the front holder 30 cannot be moved from the temporary locking position to the formal locking position. In this manner, the front holder 30 cannot be moved from the temporary locking position to the formal locking position, and accordingly, the insufficient insertion of the terminal 50 can be easily detected.

Above, the operation of the front holder 30 described with reference to FIGS. 6A and 6B with respect to the temporary locking position and the formal locking position is applicable to any of the relationship between the general terminal 50 and the general terminal receiving chamber 14, and the relationship between the short-circuiting target terminal 50 and the short-circuiting target terminal receiving chamber 14.

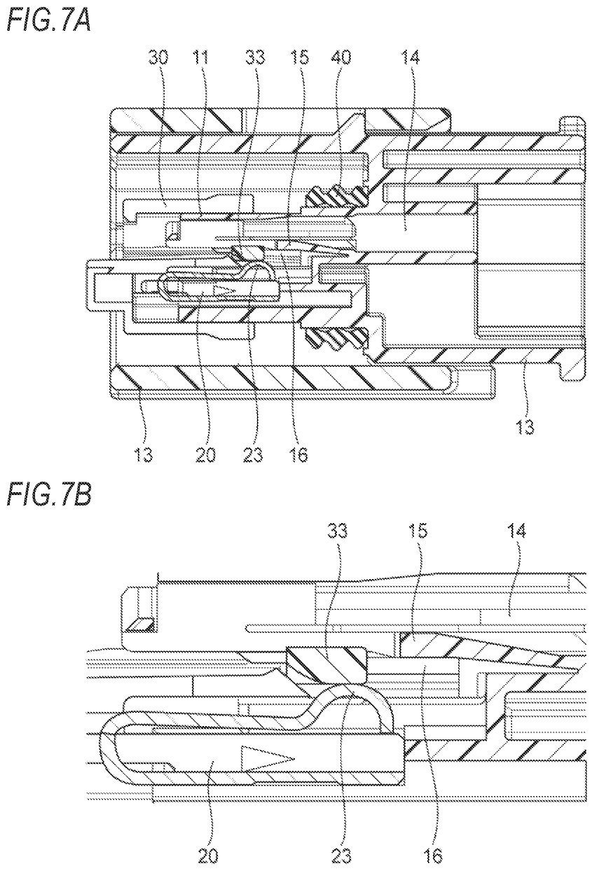

Next, a case where the short-circuiting terminal 20 is not mounted on the short-circuiting terminal mounting space 17 of the housing 10 will be described. In the connector 1 according to the embodiment of the present invention, as illustrated in FIGS. 7A and 7B, in a state where the short-circuiting terminal 20 is mounted on the short-circuiting terminal mounting space 17 of the housing 10, when the front holder 30 is mounted at the temporary locking position, the detection member (short-circuiting target detection member) 33 corresponding to the short-circuiting target terminal receiving chamber 14 is disposed between the contact member 23 of the short-circuiting terminal 20, which is elastically deformed downward, and the short-circuiting target terminal receiving chamber 14.

Therefore, as the short-circuiting target detection member 33 is pressed upward (in the direction of approaching the short-circuiting target terminal receiving chamber 14) by the contact member 23 of the short-circuiting terminal 20, the short-circuiting target detection member 33 deforms elastically upward (in the direction of approaching the short-circuiting target terminal receiving chamber 14). Therefore, as the elastically deformed short-circuiting target detection member 33 interferes with the lance 15 at the original position, it becomes impossible for the short-circuiting target detection member 33 to enter the space 16. As a result, the front holder 30 cannot be moved from the temporary locking position to the formal locking position.

As described above, in a case where the short-circuiting terminal 20 is mounted, in a state where the short-circuiting target terminal 50 is not inserted into the short-circuiting target terminal receiving chamber 14, when the front holder 30 is at the temporary locking position, the front holder 30 cannot be moved from the temporary locking position to the formal locking position. Therefore, during the conveyance, such as during shipping, it is possible to suppress unintended movement of the front holder 30 from the temporary locking position to the formal locking position.

In this manner, in order to move the front holder 30 from the temporary locking position to the formal locking position from a state where the front holder 30 cannot be moved from the temporary locking position to the formal locking position, the pair of short-circuiting target terminals 50 (four short-circuiting target terminals 50 in total) for each of the both sides in the width direction may be respectively inserted into the sufficient insertion positions of the pair of short-circuiting target terminal receiving chambers 14.

In other words, as illustrated in FIGS. 8A and 8B, by inserting the short-circuiting target terminal 50 into the sufficient insertion position, the short-circuiting target detection member 33 positioned between the short-circuiting target terminal 50 and the contact member 23 of the short-circuiting terminal 20 is pushed back downward (in the direction of going far away from the short-circuiting target terminal receiving chamber 14) by the short-circuiting target terminal 50. Therefore, as the short-circuiting target detection member 33 can enter the space 16 that faces the lower side surface of the lance 15 at the original position, a state where the front holder 30 can be moved from the temporary locking position to the formal locking position is achieved. In a case where at least one of the four short-circuiting target terminals 50 in total is not inserted into the sufficient insertion position of the corresponding short-circuiting target terminal receiving chamber 14, in the short-circuiting target terminal receiving chamber 14, due to the fact that a state where the short-circuiting target detection member 33 cannot enter the space 16 cannot be achieved, the front holder 30 cannot be moved from the temporary locking position to the formal locking position.

As described above, in a state where the front holder 30 can be moved from the temporary locking position to the formal locking position, as long as the front holder 30 is at the temporary locking position, the short-circuiting target detection member 33 is positioned between the short-circuiting target terminal 50 and the contact member 23, and thus, the pair of short-circuiting terminals 50 is not short-circuited by the short-circuiting terminal 20.

From this state, as illustrated in FIGS. 9A and 9B, when the front holder 30 is moved from the temporary locking position to the formal locking position, the short-circuiting target detection member 33 moves from between the short-circuiting target terminal 50 and the contact member 23, the contact member 23 of the short-circuiting terminal 20 moves upward (in the direction of elastic return), the pair of short-circuiting terminals 50 is respectively in directly contact with the pair of contact members 23, and accordingly, a state where the pair of short-circuiting terminals 50 is short-circuited can be obtained.

Even in a case where the short-circuiting target terminal 50 is inserted into the insufficient insertion position, similar to a case where the short-circuiting target terminal 50 is inserted into the sufficient insertion position, the short-circuiting target detection member 33 is pushed back downward by the short-circuiting target terminal 50. However, in this case, as the short-circuiting target terminal 50 is at the insufficient insertion position, the lance 15 is maintained in a posture which is elastically deformed downward. Therefore, as the tip end of the lance 15 interferes with the short-circuiting target detection member 33, it becomes impossible for the short-circuiting target detection member 33 to enter the space 16, and the front holder 30 cannot be moved from the temporary locking position to the formal locking position. In other words, the function of detecting the insufficient insertion of the short-circuiting target terminal 50 is also maintained.

Above, according to the connector 1 according to the embodiment of the present invention, in a state where the terminal 50 is not inserted into the terminal receiving chamber 14 during the conveyance, such as during shipping, when the front holder 30 is at the temporary locking position, by using the mechanism configured with the front holder 30 and the short-circuiting terminal 20, the front holder 30 cannot be moved from the temporary locking position to the formal locking position. Therefore, during the conveyance, such as during shipping, it is possible to suppress unintended movement of the front holder 30 from the temporary locking position to the formal locking position by using the short-circuiting terminal 20.

Specifically, when the front holder 30 is at the temporary locking position, by disposing the detection member 33 of the front holder 30 between the contact member 23 of the short-circuiting terminal 20 and the terminal receiving chamber 14. When the front holder 30 cannot be moved from the temporary locking position to the formal locking position and the front holder 30 is at the formal locking position, by moving the detection member 33 from between the terminal 50 and the contact member 23, the pair of short-circuiting terminals 50 can be short-circuited.

Furthermore, in a state where the pair of short-circuiting terminals 50 inserted into the formal locking position, which are targets of short-circuiting by the short-circuiting terminal 20, are connected to a wiring harness that supplies control signals to an inflator of an in-vehicle airbag system, as long as the front holder 30 is maintained at the formal locking position, it is possible to reliably prevent the occurrence of malfunctions and misfires of the inflator due to static electricity.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

In the above-described embodiment, as the “holder”, the front holder 30 mounted on the housing 10 from the front side is adopted. In contrast, as the “holder”, a rear holder mounted on the housing 10 from the rear side may be adopted.

According to the above exemplary embodiments, a connector (1) comprises:
a housing (10): having a terminal receiving chamber (14) to hold a terminal (50); and a lance (15);
a holder (30) mounted on the housing (10) to be movable in a fitting direction of the housing (10) and a counterpart housing (10) between a temporary locking position and a formal locking position, the holder (30) having a detection member (33), the holder (30) being configured to be movable to the formal locking position by being allowed a movement of the detection member (33) without an interference to the lance (15) upon the terminal (50) being at a sufficient insertion position, and the holder (30) being configured to be non-movable to the formal locking position due to the interference of the detection member (33) to the lance (15) upon the terminal (50) being at an insufficient insertion position; and
a short-circuiting terminal (20) fixed to the housing (10) and having an elastically deformable contact member (23), the contact member (23) making a contact with a plurality of the terminals (50) received in a plurality of the terminal receiving chambers (14) to cause a short-circuit of the plurality of the terminals (50),
the holder (30) and the short-circuiting terminal (20) being configured not to allow a movement of the holder (30) to the formal locking position under a first state where the holder (30) is at the temporary locking position and at least one of the plurality of the terminals (50) subjected to the short-circuit using the short-circuiting terminal (20) is not inserted into the corresponding terminal receiving chamber (14),
the holder (30) and the short-circuiting terminal (20) being configured to avoid a contact of the contact member (23) with the plurality of the terminals (50) and to allow the movement of the holder (30) to the formal locking position under a second state where the plurality of the terminals (50) subjected to the short-circuit using the short-circuiting terminal (20) are inserted into the sufficient insertion position of the plurality of the terminal receiving chambers (14), and
the holder (30) and the short-circuiting terminal (20) being configured to make the contact of the contact member (23) with the plurality of the terminals (50) to cause the short-circuit of the plurality of the terminals (50) under a third state where the holder (30) is moved to the formal locking position.

According to the above-described aspect, in a state where the terminal is not inserted. into the terminal receiving chamber during the conveyance, such as during shipping, when the holder is at the temporary locking position, the holder cannot be moved from the temporary locking position to the formal locking position. Therefore, during the conveyance, such as during shipping, it is possible to suppress unintended movement of the holder from the temporary locking position to the formal locking position by using the short-circuiting terminal.

In the connector (1),
in the first state, the movement of the holder (30) may not be allowed as the detection member (33) positioned between the contact member (23) and the terminal receiving chamber (14) is pressed in a direction of approaching the terminal receiving chamber (14) by the contact member (23) to cause the interference of the detection member (33) to the lance (15),
in the second state, the movement of the holder (30) to the formal locking position without the interference to the lance (15) may be allowed as the detection member (33) is positioned between the terminal (50) and the contact member (23) to avoid the contact of the contact member (23) to the terminal (50), and the detection member (33) is pressed in a direction of separating from the terminal receiving chamber (14) by the terminal (50), and
in the third state, the contact member (23) may come into contact with the plurality of the terminals (50) and then the plurality of the terminals (50) are short-circuited as the detection member (33) moves from between the terminal (50) and the contact member (23).

According to the above-described aspect, it is possible to short-circuit the plurality of terminals by disposing the detection member of the holder between the contact member of the short-circuiting terminal and the terminal receiving chamber when the holder is at the temporary locking position, and by moving the detection member from between the terminal and the contact member when the holder cannot be moved from the temporary locking position to the formal locking position and the holder is at the formal locking position.

Incidentally, in the connector according to the above-described first aspect or the above-described aspect, as a specific example of the plurality of terminals, which are targets of short-circuiting by the short-circuiting terminal, terminals connected to the electric wire for supplying control signals to the inflator of the in-vehicle airbag system can be used. Accordingly, it is possible to suppress the occurrence of malfunctions and misfires of the inflator due to static electricity as long as the holder is maintained at the formal locking position.

In the connector (1),
the plurality of the terminals (50) subjected to the short-circuit using the short-circuiting terminal (20) may be connected to a wiring harness to supply a control signal to an inflator of an in-vehicle airbag system.

As described above, according to the present invention, during the conveyance, such as during shipping, it is possible to suppress unintended movement of the holder from the temporary locking position to the formal locking position by using a short-circuiting terminal.

The connector of the present invention can suppress unintended movement of the holder from the temporary locking position to the formal locking position during the conveyance, such as during shipping. The present invention having this effect can be used, for example, on a circuit to supply control signals to the inflator of the in-vehicle airbag system.

What is claimed is:

1. A connector comprising:
a housing: having a terminal receiving chamber to hold a terminal; and a lance;
a holder mounted on the housing to be movable in a fitting direction of the housing and a counterpart housing between a temporary locking position and a formal locking position, the holder having a detection member, the holder being configured to be movable to the formal locking position by being allowed a movement of the detection member without an interference to the lance upon the terminal being at a sufficient insertion position, and the holder being configured to be non-movable to the formal locking position due to the interference of the detection member to the lance upon the terminal being at an insufficient insertion position; and
a short-circuiting terminal fixed to the housing and having an elastically deformable contact member, the contact member making a contact with a plurality of the terminals received in a plurality of the terminal receiving chambers to cause a short-circuit of the plurality of the terminals,
the holder and the short-circuiting terminal being configured not to allow a movement of the holder to the formal locking position under a first state where the holder is at the temporary locking position and at least one of the plurality of the terminals subjected to the short-circuit using the short-circuiting terminal is not inserted into the corresponding terminal receiving chamber,
the holder and the short-circuiting terminal being configured to avoid a contact of the contact member with the plurality of the terminals and to allow the movement of the holder to the formal locking position under a second state where the plurality of the terminals subjected to the short-circuit using the short-circuiting terminal are inserted into the sufficient insertion position of the plurality of the terminal receiving chambers, and
the holder and the short-circuiting terminal being configured to make the contact of the contact member with the plurality of the terminals to cause the short-circuit of the plurality of the terminals under a third state where the holder is moved to the formal locking position.

2. The connector according to claim 1, wherein
in the first state, the movement of the holder is not allowed as the detection member positioned between the contact member and the terminal receiving chamber is pressed in a direction of approaching the terminal receiving chamber by the contact member to cause the interference of the detection member to the lance,
in the second state, the movement of the holder to the formal locking position without the interference to the lance is allowed as the detection member is positioned between the terminal and the contact member to avoid the contact of the contact member to the terminal, and the detection member is pressed in a direction of separating from the terminal receiving chamber by the terminal, and
in the third state, the contact member comes into contact with the plurality of the terminals and then the plurality of the terminals are short-circuited as the detection member moves from between the terminal and the contact member.
